(19) United States
(12) Patent Application Publication
(10) Pub. No.: US 2023/0029993 A1
(43) Pub. Date: Feb. 2, 2023

(54) SYSTEMS AND METHODS FOR BEHAVIOR CLONING WITH STRUCTURED WORLD MODELS

(71) Applicant: TOYOTA RESEARCH INSTITUTE, INC., LOS ALTOS, CA (US)

(72) Inventors: ALBERT ZHAO, LOS ALTOS, CA (US); RARES A. AMBRUS, San Francisco, CA (US); ADRIEN D. GAIDON, Mountain View, CA (US)

(21) Appl. No.: 17/387,921

(22) Filed: Jul. 28, 2021

(51) Int. Cl. G05D 1/00; G05B 13/02; G01C 21/34

(52) U.S. Cl. CPC G05D 1/0088; G05B 13/027; G01C 21/34; B60W 60/001

(57) ABSTRACT

Systems, methods, computer-readable media, techniques, and methodologies are disclosed for generating vehicle controls and/or driving policies based on machine learning models that utilize intermediate representation of driving scenes as well as demonstrations (e.g. by behavioral cloning). An intermediate representation that includes inductive biases about the structure of driving scenes for a vehicle can be generated by a self-supervised first machine learning model. A driving policy for the vehicle can be determined by a second machine learning model trained by a set of expert demonstrations and based on the intermediate representation. The expert demonstrations can include labelled data. An appropriate vehicle action may then be determined based on the driving policy. A control signal indicative of this vehicle action may then be output to cause an autonomous vehicle, for example, to implement the appropriate vehicle action.

### TECHNICAL FIELD

The present disclosure relates generally to systems and methods for learning a latent state estimator for behavioral cloning of driving policies, and in some implementations, with self-supervised learning of inductive biases about the structure of driving scenes.

### DESCRIPTION OF RELATED ART

The current methods for autonomous driving can be classified into two categories: behavioral cloning and modular pipelines. A behavioral cloning model, generally referred to as behavioral cloning may suffer from generalization and stability issues, as well as have low sample efficiency (i.e. require extensive training sets). It may therefore may not be suitable in complex driving situations. For example, although behavioral models may learn some rule of the roads (such as learning speed limits based on observed road signs), these models may not know about every rule of the road. For example, it may require many miles driven, for the model to be able to anticipate every possible driving situation (i.e. low sample efficiency). Further, the behavioral learning may not anticipate any or every pedestrian action, and the model may not yield good results in specific contexts. These models may also not be able to anticipate intermediate drivers (i.e. they may model vehicles as perfect, lawful drivers).

On the other hand, modular pipelines, which use computer vision methods to learn an explicit representation of the world are not easily scalable due to the labor intensive process of labelling the representation and may also be error prone because of compounding of errors. For example, some systems can utilize hard-coded aspects of the intermediate representation (for example, by high definition mapping, real-time traffic information, real-time communication between vehicles and infrastructure). Generating a planned trajectory from this high level, yet hard-coded intermediate representation may still require supervision of intermediate representations.

Supervised machine learning models may be trained by labelled datasets. Unsupervised or self-supervised machine learning models may be trained by unlabeled datasets. Self-supervised machine learning models can instead obtain training data from the data itself, such as by leveraging the underlying structure in the data.

### BRIEF SUMMARY OF THE DISCLOSURE

A behavioral cloning model, generally referred to behavioral cloning, may scale well to a variety (e.g. routine) driving situations because it learns using only expert demonstrations. The controls or driving policy may be difficult to learn, because in view of the data, the scene should be decomposed and individual elements should be supervised (for example, to mitigate errors). The way the sensors for real-time data utilize the dearth of information is by a neural network. This scheme may also make mistakes. For example, the planning system may blindly trust the output of a computer vision or computer vision system. In other words, there may be false negatives (i.e. the system determining that it is safe to pass, but there is an obstacle, such as a pedestrian). In order to fix these problems,

The present disclosure improves upon current technology by utilizing the benefits of both technologies to yield better generalization than end-to-end behavioral cloning, without the laborious cost of modular methods.

The present disclosure includes systems and methods for self-supervised learning of inductive biases about the structure of driving scenes (i.e. an intermedia representation) to regularize the intermediate state of policies trained using behavioral cloning. The self-supervised learning enables continual learning (e.g. with the collection of more expert demonstrations) and the fixed (or semi-fixed) structure of the inductive biases ensure compatibility with physical constraints and other priors, which among other benefits can limit drift.

On the other hand, modular pipelines, which use computer vision methods to learn an explicit representation of the world, generalize well but are not scalable due to the labor intensive process of labelling the representation and may also be error prone because of compounding of errors. For example, some systems can utilize hard-coded aspects of the intermediate representation (for example, by high definition mapping, real-time traffic information, real-time communication between vehicles and infrastructure). Generating a planned trajectory from this high level, yet hard-coded intermediate representation may still require supervision of intermediate representations. The controls or driving policy may be difficult to learn, because in view of the data, the scene should be decomposed and individual elements should be supervised (for example, to mitigate errors). The way the sensors for real-time data utilize the dearth of information is by a neural network. This scheme may also make mistakes. For example, the planning system may blindly trust the output of a computer vision or computer vision system. In other words, there may be false negatives (i.e. the system determining that it is safe to pass, but there is an obstacle, such as a pedestrian).

The present disclosure improves upon current technology by utilizing the benefits of both technologies to yield better generalization than end-to-end behavioral cloning, without the laborious cost of modular methods.

The present disclosure includes systems and methods for self-supervised learning of inductive biases about the structure of driving scenes (i.e. an intermedia representation) to regularize the intermediate state of policies trained using behavioral cloning. The self-supervised learning enables continual learning and the fixed structure of the inductive biases ensure compatibility with physical constraints and other priors that can limit drift.

According to various embodiments of the disclosed technology, a system is disclosed that includes at least one memory storing machine-executable instructions and at least one processor configured to access the at least one memory and execute the machine-executable instructions to perform a set of operations. The set of operations include generating by a self-supervised first machine learning model, an intermediate representation comprising inductive biases about the structure of driving scenes for a vehicle. The set of operations can include determining, by a second machine learning model trained by a set of expert demonstrations comprising labelled data, and based on the intermediate representation, a driving policy for the vehicle. The set of operations can include generating a control signal for an actuator of the vehicle based on the determined driving policy.

In various embodiments, the intermediate representation can include a component of a world model. In some embodiments, the inductive biases comprise geometric scene decomposition. The geometric scene decomposition can be inferred by self-supervised ego-motion and depth networks. In some embodiments, the inductive biases include semantic inductive biases inferred from self-supervised scene flow. In various embodiments, the inductive biases include temporal inductive biases. According to various aspects of the disclosed technology, the inductive biases include freespace affordances generated by self-supervised depth and traversability analysis.

According to various embodiments, the determined driving policy can be determined by imposing the intermediate representations as constraints on unconstrained driving policies, as determined based on the expert demonstrations. In some embodiments, the intermediate representations include fixed bounds within which the determined driving policy for the vehicle is determined.

According to various embodiments of the disclosed technology, a method is disclosed that can be implemented on a computer. The method can include generating, by a self-supervised first machine learning model, an intermediate representation. The intermediate representation can include inductive biases about the structure of driving scenes for a vehicle. The method can include determining, by a second machine learning model a driving policy for the vehicle. The second machine learning model can be trained by a set of expert demonstration and based on the intermedia representation. The expert demonstration can include labelled data.

In various embodiments, the method includes controlling an operation of the vehicle in response to a control signal generated based on the determined driving policy. In some embodiments, the intermediate representation can include a world model. In some embodiments, the inductive biases can include geometric scene decomposition.

In some embodiments, the geometric scene decomposition can be inferred from a self-supervised ego-motion network. In various embodiments, the geometric scene decomposition can be inferred from self-supervised depth networks. In some embodiments, the inductive biases comprise semantic inductive biases inferred from self-supervised scene flow.

In some embodiments, the inductive biases include temporal inductive biases. In some embodiments, the inductive biases include freespace affordances. The freespace affordances can be generated by self-supervised depth analysis. In some embodiments, the freespace affordances can be generated by self-supervised traversability analysis.

In some embodiments, the determined driving policy can be determined by imposing the intermediate representations as constraints on unconstrained driving policies as determined based on the expert demonstrations.

In some embodiments, the intermediate representations can include fixed bounds within which the determined driving policy for the vehicle is determined.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A depicts an example workflow for end-to-end behavioral cloning systems in accordance with example embodiments.

FIG. 1B shows an example workflow for engineering modular pipeline systems in accordance with example embodiments.

FIG. 2 shows an example workflow for implementing a driving model according to aspects of the present disclosure.

FIG. 3 illustrates an workflow for example circuit architecture for implementing a driving model in accordance with example embodiments.

FIG. 4A is a flowchart of an illustrative method for generating driving controls and/or policies in accordance with example embodiments.

FIG. 4B is a flowchart of an illustrative method for generating driving controls and/or policies in accordance with example embodiments.

FIG. 5 is an example computing component that may be used to implement various features of embodiments of disclosed technology.

The figures are not exhaustive and do not limit the present disclosure to the precise form disclosed.

### DETAILED DESCRIPTION

Example embodiments disclosed herein relate to, among other things, systems, methods, computer-readable media, techniques, and methodologies for autonomous driving that combine the benefits of behavioral cloning and modular pipelines. In particular, in example embodiments, a world model is generated from which inductive biases can be self-supervised or learned without human supervision.

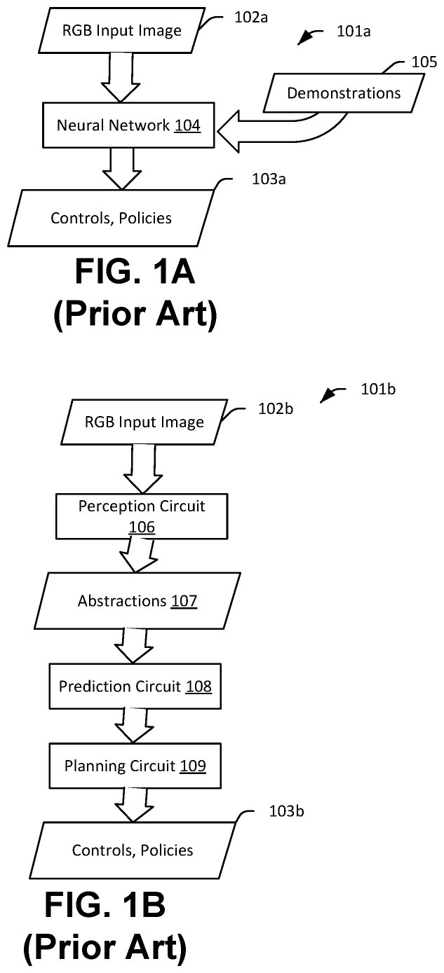

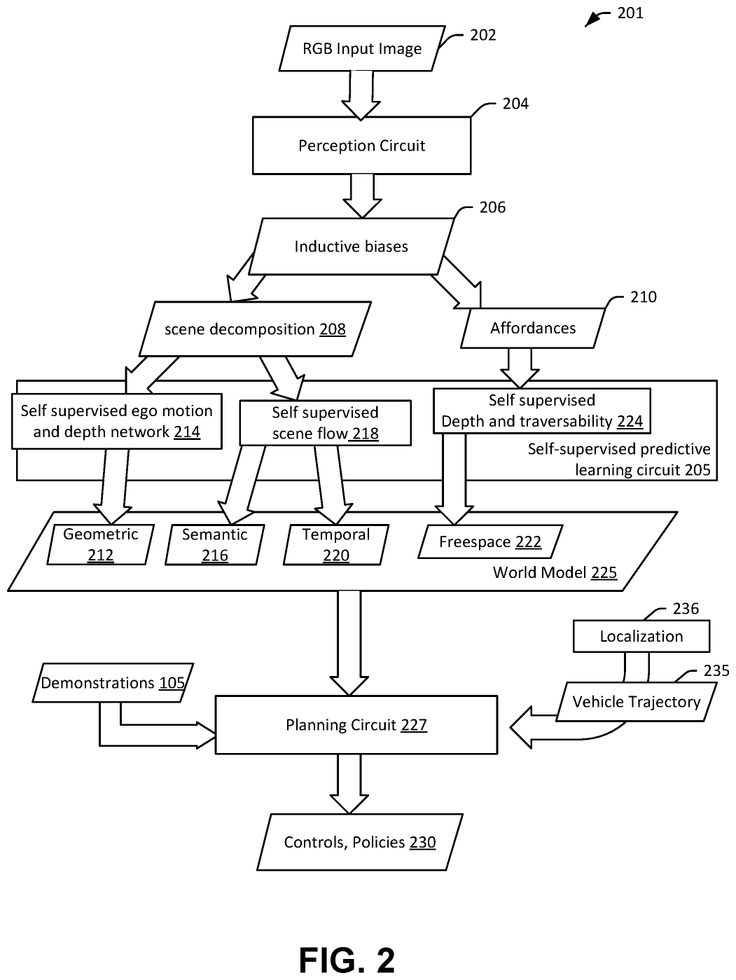

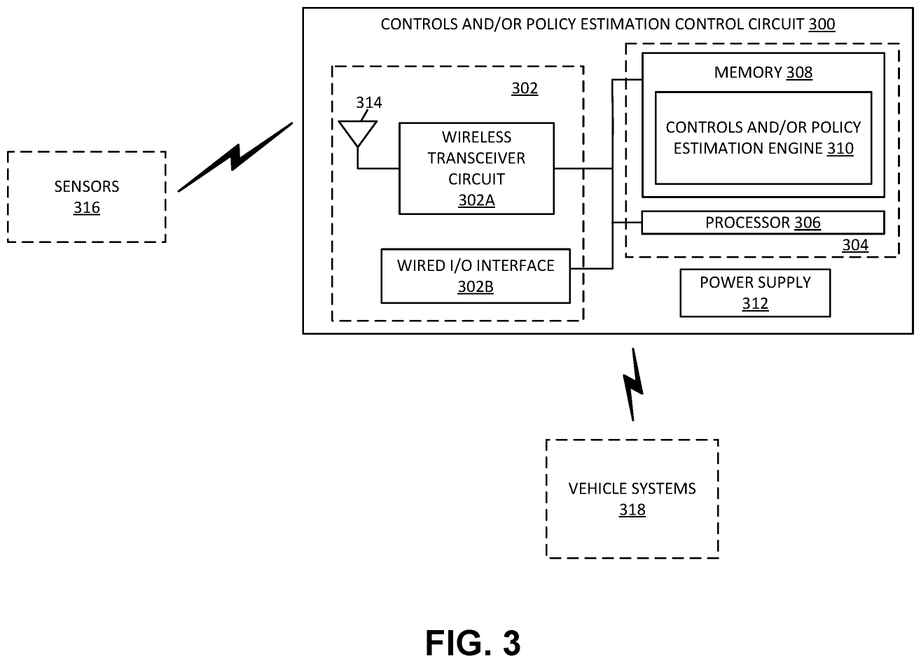

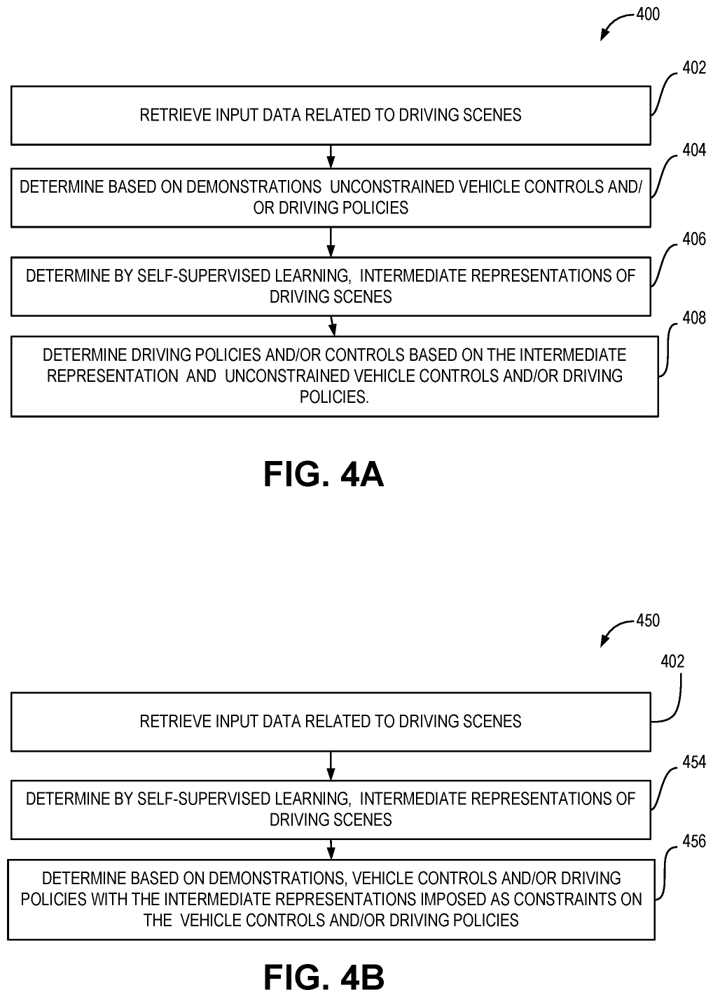

As alluded to above, methods for autonomous driving can be classified into two categories: behavioral cloning and modular pipelines. FIG. 1A shows one example workflow 101a for an end-to-end or behavioral cloning system, while FIG. 1B shown an example workflow 101b for an engineered system that utilizes modular pipelines. FIG. 2 shows an example workflow 201 for implementing a driving model according to aspects of the present disclosure. FIG. 3 illustrates an example circuit architecture for implementing a driving model according to aspects of the present disclosure. FIGS. 4A and 4B show flowcharts of illustrative methods 400, 450, for implementing driving models in accordance with example embodiments. FIGS. 1A, 1B, 2, 3, 4A, 4B will be described at various times hereinafter in conjunction with one another.

A behavioral cloning system may intend to replicate the driving of a good or average driver. In other words, it creates a system that can replicate a good or average driver. It can be a machine learning based system that learns from raw data (e.g. by classifying human driven miles with good and/or bad driving behaviors) and navigates the world based on that information. Behavioral cloning based systems can include a neural network, that takes as input sensory information (e.g. video stream, lidar, etc.) and outputs vehicle controls (steering angle, throttle, acceleration/braking). As shown in FIG. 1A, a behavioral cloning system that can take various inputs 102a, such as input images, speed information, etc. and generate an output 103b (e.g. one or more control signals/control inputs and/or driving policies) by applying a machine learning model executed at a neural network 104 that utilizes (expert) demonstrations 105 (e.g. as part of training the neural network 104). The demonstrations 105 can allow for cloning the behaviors of drivers. A shown in FIG. 1A, workflow 101a implements an end-to-end system in that it generates the output 103a (i.e. controls and/or driving policies) directly from the raw data (input 102a).

The goal of an engineered system (i.e. by engineered modular pipelines) includes to represent (i.e. by generating abstractions or inductive biases) what there is to learn about driving. FIG. 1B shows an example workflow 101b for an engineered system, that generates from inputs 102b, output 103b controls and/or policies. An engineered system can include a perception circuit 106 that tries to abstract the sensor information (i.e. turn them into abstractions 107, e.g. agents, motion, routing, locations/mapping), a prediction circuit 108 (e.g. configured to infer how the world will evolve, how specific agents will move/evolve), and a planning circuit 109. Generating the abstraction 107 by workflow 101b may require laborious training. For example, generating one type of abstraction may require classifying freespace in a vicinity of a vehicle. The planning circuit 109 may be configured to make decisions on how to traverse the world (e.g. crossing an intersection, how to traverse a merging zone), based on real-time information from the perception circuit 106 and predictions from the prediction circuit 108.

As alluded to above, the present disclosure improves upon current technology utilizing the benefits of both technologies (behavioral cloning and modular engineered pipelines) to yield better generalization than end-to-end behavioral cloning, without the laborious cost of engineered systems. As such, the present disclosure allows for applying the benefits of a system for cloning the behaviors of drivers, while utilizing the benefits of generated abstractions or inductive biases about the world. The system and methods described herein can self-supervise the learning of inductive biases.

The present disclosure can include generating a world model (i.e. a representation of aspects of a driving scene, such as vehicles, pedestrians, weather, roadways, etc.) that is capable of not only representing a static state of the world, but a dynamic world (i.e. including representations for how the world will evolve as a whole). In methods and systems described herein, the world model can include inductive biases. Based on that model, the system and methods described herein can learn how to drive based on demonstrations. In other words, the end-to-end driving model (including the world model) can be learned based on demonstrations.

In systems and methods described herein, to assist in utilizing demonstrations (i.e. to learn a better driver), the system can utilize some prior modelled and/or predicted knowledge about the world (inductive biases including scene decomposition and affordances). As such, inductive biases can become part of the previously mentioned world model.

FIG. 2 shows an example workflow 201 for implementing a driving model according to aspects of the present disclosure. The driving model of workflow 201 can take inputs 202 (e.g. input images, speed of an ego vehicle, vehicle state information, etc.) and at least by a perception circuit 204 and/or self-supervised predictive learning circuit, generally prediction circuit 205, can generate one or more inductive biases 206. Although perception circuit 204 is shown separate from prediction circuit 205, these circuits can be implemented by a single circuit, and/or aspects of the functionality for the circuits can be divided among the circuits. Perception circuit 204 and/or prediction circuit 205 can implement aspects of a self-supervised learning model that can take as input 202 and/or extract one or more information corresponding to driving scenes. Driving scenes can include bird-eye view representations of driving scenes or driving scenarios. Driving scenes can include first person images from vehicles. Driving scenes can include contextual information about the driving environment. Input 202 may include a two-dimensional (2D) RGB image which may be a particular image frame of a series of image frames captured over time.

The driving model implemented by workflow 201 can learn and/or utilize inductive biases 206 (e.g. scene decomposition 208 and/or affordances 210) without having to individually classify or train the inductive biases 206 (i.e. by reinforcement learning). As such, these inductive biases 206 can be self-supervised, for example by self-supervised predictive learning prediction circuit 205. Prediction circuit 205 can be trained using un-labeled datasets. can apply self-supervised predictive learning by being trained using un-labeled datasets.

Inductive biases 206 can include scene decomposition 208 (e.g. that the scene can be decomposed into separate entities) and affordances 210. Regarding scene decomposition, scene decomposition can include both geometric 212 scene decomposition (inferred from self-supervised ego-motion and depth networks 214), semantic 216 scene decomposition (e.g., dynamic vs static objects inferred from self-supervised scene flow 218), and/or temporal 220 (e.g. contrastive loss and latent space dynamics) scene decomposition. For example, regarding scene decomposition 208, the disclosed system can leverage 3D geometric structure 212 (e.g. self-supervised ego-motion and depth), semantics 216 (e.g. image segmentation and dynamic vs. static objects inferred from self-supervised scene flow) and temporal dynamics 220 (e.g. learning environment dynamics in latent feature space, e.g. via contrastive loss). As a specific example, temporal dynamics 220 that can be leveraged can include that certain aspects of the scene are closer to each other in the scene (temporally), such as the operation of traffic lights), while semantics 216 can include that aspects of the scene may be associated or related (e.g. a stop line under the traffic light). As a further example, temporal dynamics 220 that can be leveraged can include that things farther in time should be father in representation, while a temporal smoothness may be inferred. Regarding affordances 210, affordances 210 can include freespace 222 (the empty space available to the agent). Freespace 222 can be determined from self-supervised depth and traversability analysis 224 (i.e. determining where the agent can traverse safely). Depth and traversability analysis can include determination of visible and hidden traversable surfaces.

The workflow 201 can generate a self-supervised world model 225, wherein inductive biases 206 can be self-supervised or learned from the raw input 202 data (e.g. from the scene) itself (e.g. learned without additional supervision). Perception circuit 204 and prediction circuit 205 can generate the world model 225 and can utilize and/or include the inductive biases 206 (such as geometric 212, semantic 216, temporal 220, and/or freespace 222).

The self-supervised learning module can be configured to learn the structure of driving scenes from the information that may learned from the driving scene. In other words, the self-supervise learning module can take unstructured data and learn the structure of the driving scenes. The self-supervised learning module can learn the inductive biases about the structure of the driving scenes. In other words, the inductive biases can be extracted from the driving scenes. The self-supervised learning module can learn the inductive biases about the structure of the driving scenes by utilizing a fixed structure of the inductive biases. The fixed (or semi-fixed, or flexible) structure can correspond to one or more bounds or limits imposed on the driving policy and/or controls. The self-supervised learning module can carry out one or more pattern recognition and or statistical estimation tasks for learning the inductive biases about the structure of driving scenes.

A planning circuit 227 can operate with the perception circuit 204 and prediction circuit 205 in order to determine the planned vehicle action or route. The planning circuit 227 can be or include a machine learning model or neural network (e.g. deep neural network), which in turn, may be a particular implementation of a behavioral leaning model. The machine learning model may (and respective neural network) may have been trained utilizing one or more expert demonstrations. Expert demonstrations as used herein can include demonstrations from human drivers, but are not limited to expert drivers (e.g. drivers with a specific skillset or experience level). For example, expert demonstrations can include demonstrations from poor, average, rule-abiding, and/or rule breaking drivers. Expert demonstrations as used herein can include privileged expert agents, for example, agents that possess knowledge of at least a portion of the driving map and/or ego vehicle location. Although one intention of behavioral cloning may be to model or imitate a good driver, this is exemplary only. It can also be understood that “behavioral cloning” as used herein with reference to planning circuit 227 includes modelling and/or imitating (or intentionally not modelling or not imitating) poor drivers, average drivers, and/or non-law abiding drivers.

The planned vehicle action or route can indicative of an appropriate vehicle action to be taken. The planned vehicle action can correspond to waypoints, controls data and/or control input for a vehicle system. As such, planning circuit 227 (and/or by assistance from another circuit, such as a control input generation circuit, which is not shown in FIG. 2) can also generate one or more controls and/or policies 230. It can be understood that planning circuit 227 can generate driving policies, waypoints and/or planned vehicle actions, including based on one or more training data. In embodiments, the driving policies include the waypoints and/or vehicle trajectories. In embodiments, behavioral cloning, and/or imitation learning can be utilized. The training data may include expert demonstrations 105. The training data can include expert demonstrations associated with one or more inductive biases associated with the driving scenes utilizing the expert data. It is also understood that expert demonstrations 105 can include demonstrations by privileged expert agents, for example, agents that possess knowledge of at least a portion of the driving map and/or ego vehicle location.

It can also be understood that these policies, waypoints, and/or planned vehicle actions can be translated into control signals for the vehicle, for example by a low-level controller, such as by a proportional integral derivative (PID) controller. Control signals can implement one or more vehicle action. In examples, the workflow 201 can include generating a vehicle trajectory 235 by a localization circuit 236. In embodiments, the policies 230 generated can include updated vehicle trajectory for the vehicle as determined by planning circuit 227.

Localization circuit 236 may determine/obtain localization information for a vehicle. This information may be based on the same and/or additional inputs 202 which were used by perception circuit 204 and/or prediction circuit 205. In example embodiments, the localization information may include vehicle trajectory information 235 that indicates, for example, a current lane of travel for the vehicle. In example embodiments, the vehicle trajectory information 235 may further include a planned navigation route for the vehicle. For instance, as an autonomous vehicle approaches a signalized intersection, its planned trajectory may call for the vehicle to make a left turn at the intersection. In order to do so, the vehicle may need to move from a current travel lane to a left-turn-only lane. Once the autonomous vehicle moves into the left-turn-only lane, this lane may then be identified as the current lane of travel in the vehicle trajectory information 235. In some example embodiments, the vehicle system(s) may determine the vehicle's current lane based on its Global Positioning System (GPS) coordinates and map data. For instance, vehicle system(s) may determine the vehicle's location based on GPS coordinates received from an onboard GPS device and then compare that location to map data to determine the vehicle's current lane of travel. The map data may be granular enough to reveal which lane boundaries the vehicle's location falls between, and thus, which lane the vehicle is traveling in. Vehicle trajectory information 235 may be useful in determining new controls and/or driving polices 230, including updated vehicle trajectories.

Referring back to the benefits of combining a behavioral cloning system with engineered systems utilizing modular pipelines, the system can learn the control and/or driving policies end-to-end, but the system can also be modular (i.e. without sacrificing the structure of the representation). While the driving policy or controls can be learned end to end, the learned inductive biases (i.e. the structure of intermediate representation) can act as a learning constraint. As such, the (self-supervised) learned inductive biases can act as learning constraints on the driving policies or controls. Thus, the inductive biases or intermediate representations, can benefit the end-to-end system for learning the policies, by requiring that the inductive biases must have a significance for the learned driving policy or controls 230. For example, the inductive biases can force the data to be a specific type of data or information by paying self-supervised type of loss. In other examples, the intermediate representations of driving scenes can correspond to one or more bounds or limits imposed on the driving policy and/or controls. For example, bounds or limits can be imposed in that driving policy and/or controls should stay within the one or more bounds or limits.

As previously alluded to, decomposing the scene, e.g. scene decomposition 208 (e.g. by perception circuit 204) can leverage 3D geometric structure 212 (e.g. self-supervised motion and depth). Decomposing the scene can allow for determining and predicting free space (i.e. available space) and/or the objects that the vehicle can collide with). This information can be used by the system (e.g. by planning 227 and/or prediction 205 circuit) to output a point cloud or 3D geometry information. The system may not require reinforcement learning for (i.e. by human classification, labelling, or training) the generated output or 3D geometry information. That representation is not supervised, but it is learned from the raw data itself. The system may rather penalize (i.e. impose a penalty) when the system has made a mistake (e.g. in predicting the 3D structure, depth, ego-motion, e.g.), and/or reward when the system has made correct prediction.

One circuit (i.e. perception 205 and/or prediction circuit 205) outputs an (intermediate) representation (i.e. world model 225 together with self-supervised inductive biases), and another circuit, e.g. planning circuit 227, from the representation (e.g. world model 225 and/or the inductive biases), outputs controls and/or driving policies 230. Both circuits can implement machine learning modules. The only inputs for learning both the world model 225 and the policy and/or controls 230 can be the raw data (e.g. from the scene) and the demonstrations 105. In other words, from the raw data input 202 and the demonstrations 105, the world model 225, and the policies/controls 230 can be learned. This can allow for the system to learn the driver. Determining the world model 225 can assist in learning the controls/driving policy 230, because instead of learning the controls/policy straight from the raw date related to the scene, it is learned from an intermediate representation. For example, the perception 204 and prediction circuit 205 can output from the raw data input 202, intermediate representations (e.g. as part of world model 225), which the system can self-supervise. Although the intermedia representations can be self-supervised, it can be understood that the intermediate representations can be fine-tuned based on expert demonstrations and/or by the use of labelled training data.

Inductive biases can include scene decomposition (that the scene can be decomposed into separate entities) and affordances. Regarding scene decomposition, scene decomposition can include both geometric (inferred from self-supervised ego-motion and depth networks), semantic (e.g., dynamic vs static objects inferred from self-supervised scene flow), and/or temporal (contrastive loss and latent space dynamics) scene decomposition. For example, regarding scene decomposition, the disclosed system can leverage 3D geometric structure (e.g. self-supervised ego-motion and depth), semantics (e.g. image segmentation and dynamic vs. static objects inferred from self-supervised scene flow) and temporal dynamics (e.g. learning environment dynamics in latent feature space, e.g. via contrastive loss). As a first example, the relationship between the appearance of objects can be useful in determining the scene depth (e.g. far-away objects may not move as fast as close objects). As a specific example, temporal dynamics that can be leveraged can include that certain aspects of the scene are closer to each other in the scene (temporally), such as the operation of traffic lights), while semantics can include that aspects of the scene may be associated or related (e.g. the stop line under the traffic light). As a further example, temporal dynamics that can be leveraged can include that things farther in time should be father in representation, while a temporal smoothness may be inferred. Regarding affordances, affordances can include freespace (the empty space available to the agent). Freespace can be determined from self-supervised depth and traversability analysis (i.e. determining where the agent can traverse safely). One example of self-supervised depth networks include estimating depth (e.g. a depth map) by imposing geometrical constraints on image sequences to self-supervise. In some examples, geometrical constraints depend on one or more recognized patterns. As anther example, self-supervised scene flow estimation can allow for obtaining 3d structure and/or 3d motion from temporally consecutive and/or stereo images. Scene flow estimation can include solving one or more optimization problems, and/or utilizing one or more appearance-based patterns. Scene flow estimation can include aligning visually similar image regions and/or maximizing one or more priors, such as piecewise rigid motion and piecewise planar depth.

By self-supervising these inductive biases, the present disclosure can enable the agent to continually learn with the collection of more and more expert demonstrations. The fixed structure of the inductive biases used can ensure that they are compatible with physical constraints and other priors that can be incorporated to limit drift.

In other words, to help the system utilize demonstrations (i.e. learn a better driver), the system can utilize some prior modelled and/or predicted knowledge about the world (inductive biases including scene decomposition and affordances).

Various technical features and aspects of embodiments of disclosed technology that yield the above-described technical solutions and their resulting technical benefits will now be described in more detail in reference to the Figures and the illustrative embodiments depicted therein.

Referring now to FIG. 3, an example implementation of a controls and/or policy estimation control circuit 300 is depicted. The control circuit 300 may, for example, be configured to execute machine-executable instructions contained in a controls and/or policy estimation engine 310 to estimate and generate vehicle controls and/or policies based on aspects of the present disclosure. The control circuit 300 may be provided in a vehicle, such as an autonomous vehicle. For instance, control circuit 300 can be implemented as part of an electronic control unit (ECU) of a vehicle or as a standalone component. The example control circuit 300 may be implemented in connection with any of a number of different vehicles and vehicle types including, without limitation, drones, automobiles, trucks, motorcycles, recreational vehicles, or other on-or off-road vehicles. In addition, example embodiments may be implemented in connection with hybrid electric vehicles, gasoline-powered vehicles, diesel-powered vehicles, fuel-cell vehicles, electric vehicles, or the like. The control circuit 300 may also be implemented as part of support equipment and/or infrastructure configured to support vehicles. In systems, the control circuit 300 can be implemented in simulation. For example input 202 can be inputs to the simulated vehicle (e.g. based on real and/or modelled inputs).

In the example implementation depicted in FIG. 3, the control circuit 300 includes a communication circuit 302, a decision circuit 304 (including a processor 306 and a memory 308 in this example) and a power supply 312. While components of the control circuit 300 are illustrated as communicating with each other via a data bus, other communication interfaces are also contemplated. Although not depicted in FIG. 3, the control circuit 300 may include a switch (physical or virtual) that allows a user to toggle the functionality of the control circuit 300 disclosed herein on and off.

Processor 306 can include a graphical processing unit (GPU), a central processing unit (CPU), a microprocessor, or any other suitable processing unit or system. The memory 308 may include one or more various forms of memory or data storage (e.g., flash memory, random access memory (RAM), etc.). Memory 308, can be made up of one or more modules of one or more different types of memory, and may be configured to store data and other information as well as operational instructions that may be used by the processor 306 to implement functionality of the control circuit 300. For example, the memory 308 may store a controls and/or policy estimation engine 310, which may include computer-executable/machine-executable instructions that, responsive to execution by the processor 306, cause various processing to be performed in connection with generating controls and/or policies based on self-supervised inductive biases and/or expert demonstrations, for example by the workflow 201 as depicted in FIG. 2.

The executable instructions of the engine 310 may be modularized into various computing modules, each of which may be configured to perform a specialized set of tasks associated with generating controls and/or policy estimation, such as decomposing scenes, self-supervising ego-motion and depth, inferring the presences of static and/or dynamic objects by self-supervised scene flow, etc. It can also be understood that computing modules can include and/or execute one or more machine learning models. It is understood that one or more computing modules of engine 310 can be configured to execute one or more aspects of circuits depicted in FIG. 2, such as perception circuit 204, prediction circuit 205, planning circuit 227 and/or localization circuit 236. It can be understood that each computing module may be configured to perform a specialized set of tasks as part of implementing functionality of the engine 310. The engine 310 may include one or more machine learning model, which in turn, may include one or more modules configured to execute one or more aspects of circuits depicted in FIG. 2, such as perception circuit 204, prediction circuit 205, planning circuit 227 and/or localization circuit 236. The machine learning model may be, for example, an artificial neural network (ANN) such as a deep neural network (DNN). For example, the machine learning model can be implemented as at least one of a feedforward neural network, convolutional neural network, long short-memory network, autoencoder network, deconvolutional network, support vector machine, inference and/or trained neural network, or recurrent neural network (RNN), etc. Such algorithms can include supervised, unsupervised, and/or reinforced learning algorithms. For example, machine learning models can allow for performing one or more learning, classification, tracking, and/or recognition tasks.

The ground-truth data may be image data including multiple image frames corresponding to various driving scenes, and related inductive biases. In some embodiments, The ground-truth data may be image data including multiple image frames corresponding to various driving scenes, and related labelled controls and policies based on demonstrations. Alternatively, the machine learning model may employ other types of supervised (and/or self-supervised) machine learning algorithms such as regression models, classifiers, or the like. The respective processing performed by these various modules will be described in more detail in reference to FIGS. 2 and 4. It should be appreciated that the number of modules and the tasks associated with each module depicted in FIG. 2 and/or as discussed with reference to engine 310 are merely illustrative and not restrictive. The engine 310 may include more or fewer modules than what is discussed herein and/or shown in FIG. 2, and the partitioning of processing between the modules may vary. Further, any module depicted as a sub-module of another module may instead be a standalone module, or vice versa. Moreover, each module may be implemented in software as computer/machine-executable instructions or code; in firmware; in hardware as hardwired logic within a specialized computing circuit such as an ASIC, FPGA, or the like; or as any combination thereof. It should be understood that any description herein of a module or a circuit performing a particular task or set of tasks encompasses the task(s) being performed responsive to execution of machine-executable instructions of the module and/or execution of hardwired logic of the module.

Although the example of FIG. 3 is illustrated using processor and memory circuitry, as described below with reference to circuits disclosed herein, decision circuit 304 can be implemented utilizing any form of circuitry including, for example, hardware, software, firmware, or any combination thereof. By way of further example, one or more processors; controllers; application specific integrated circuits (ASICs); programmable logic array (PLAs) devices; programmable array logic (PAL) devices; complex programmable logic devices (CPLDs); field programmable gate arrays (FPGAs); logical components; software routines; or other mechanisms might be implemented to make up the control circuit 300. Similarly, in some example embodiments, the engine 310 can be implemented in any combination of software, hardware, or firmware.

Communication circuit 303 may include a wireless transceiver circuit 302A with an associated antenna 312 and/or a wired input/output (I/O) interface 302B with an associated hardwired data port (not illustrated). As this example illustrates, communications with the control circuit 300 can include wired and/or wireless communications. Wireless transceiver circuit 302A can include a transmitter and a receiver (not shown) to allow wireless communications via any of a number of communication protocols such as, for example, an 802.11 wireless communication protocol (e.g., WiFi), Bluetooth, near field communications (NFC), Zigbee, or any of a number of other wireless communication protocols whether standardized, proprietary, open, point-to-point, networked or otherwise. Antenna 312 is coupled to wireless transceiver circuit 302A and is used by wireless transceiver circuit 302A to transmit radio frequency (RF) signals wirelessly to wireless equipment with which it is connected and to receive radio signals as well. These RF signals can include information of almost any sort that is sent or received by the control circuit 300 to/from other entities such as vehicle sensors 316, other vehicle systems 318, or the like.

A vehicle, such as an autonomous vehicle, can include a plurality of sensors 316 that can be used to detect various conditions internal or external to the vehicle and provide sensed conditions to, for example, the control circuit 300. In example embodiments, the sensors 316 may be configured to detect one or more conditions directly or indirectly such as, for example, fuel efficiency, motor efficiency, hybrid efficiency, acceleration, etc. In some embodiments, one or more of the sensors 316 may include their own processing capability to compute the results for additional information that can be provided to, for example, an ECU and/or the control circuit 300. In other example embodiments, one or more sensors may be data-gathering-only sensors that provide only raw data. In further example embodiments, hybrid sensors may be included that provide a combination of raw data and processed data. The sensors 316 may provide an analog output or a digital output. It can be understood that output from sensors 316, can be directly or indirectly provided as input 202 to the workflow 201 depicted in FIG. 2.

One or more of the sensors 316 may be able to detect conditions that are external to the vehicle as well. Sensors that might be used to detect external conditions can include, for example, sonar, radar, lidar or other vehicle proximity sensors, and cameras or other image sensors. Image sensors can be used to detect, for example, objects associated with a signalized intersection. While some sensors can be used to actively detect passive environmental objects, other sensors can be included and used to detect active objects such as those objects used to implement smart roadways that may actively transmit and/or receive data or other information.

Referring again to the control circuit 300, wired I/O interface 302B can include a transmitter and a receiver (not shown) for hardwired communications with other devices. For example, wired I/O interface 302B can provide a hardwired interface to other components, including vehicle sensors or other vehicle systems. Wired I/O interface 302B can communicate with other devices using Ethernet or any of a number of other wired communication protocols whether standardized, proprietary, open, point-to-point, networked or otherwise.

Power supply 312 can include one or more batteries of one or more types including, without limitation, Li-ion, Li-Polymer, NiMH, NiCd, NiZn, NiH2, etc. (whether rechargeable or primary batteries); a power connector (e.g., to connect to vehicle supplied power); an energy harvester (e.g., solar cells, a piezoelectric system, etc.); or any other suitable power supply.

Referring now to FIG. 4A and FIG. 4B, in conjunction with FIGS. 2 and 3, methods 400, 450, for implementing aspects of workflow 201 of FIG. 2 are shown. Methods 400, 450 can be implemented at control circuit 300 (e.g. engine 310) with reference to FIG. 3. Methods 400, 450 can be implemented on vehicles, and/or in simulation. Methods 400, 450 can be implemented as part of real-world vehicle navigation, and/or in order to train one or more machine learning models described herein. At step 402 of the method 400, input data related to driving scenes may be received, which can be inputs to machine learning models discussed herein. In example embodiments, as depicted in FIG. 2, the input image may be a two-dimensional (2D) RGB image and the machine learning model may be a deep neural network, which in turn, may be a particular implementation of the perception and/or prediction circuits depicted in FIG. 2.

At step 404 of the method 400, unconstrained vehicle controls and/or driving policies may be generated. These may be generated by planning circuit 227 as shown with reference to FIG. 2, and can be implemented by a machine learning model executed by a deep neural network which may have been previously trained based on ground-truth image data corresponding to one or more driving scenes. The ground-truth data may include one or more expect demonstrations, such as demonstrations 105 as discussed with reference to FIG. 2.

At step 406 of the method 400, the intermediate representations of driving scenes may be generated. The intermediate representations can correspond to intermediate representations as part of a world model, such as world model 225 shown with reference to FIG. 2. For instance, referring to FIGS. 2 and 3, based on the input image 202, method 400 may execute one or more aspects of perception circuit 204 and/or prediction circuit 205 may, by self-supervised learning, execute one or more aspects of self-supervised to extract a one or more inductive biases. Inductive biases 206 can include scene decomposition 208 (e.g. that the scene can be decomposed into separate entities) and affordances 210. For example, step 406 can include determining geometric scene decomposition by executing aspects of self-supervised ego-motion and/or depth networks 214. In order examples, step 406 can include determining geometric structure by executing self-supervised ego-motion and depth analysis. In other examples, step 406 can include determining semantics 216 (e.g. image segmentation and dynamic vs. static objects) by self-supervised scene flow analysis. As another example, step 406 can include determining freespace 222 by self-supervised depth and traversability analysis 224.

It can be understood that the intermediate representations of driving scenes can include one or more annotations, linkages, and/or features in the driving scenes, and can include a world model 225 corresponding to the driving scene.

At step 408 of method 400, method 400 can include determining driving policies and/or controls based on the intermediate representation (i.e. as determined at step 404) and unconstrained vehicle controls and/or driving policies (i.e. as determined at step 406). The driving policies, waypoints, and/or controls can be utilized so that the vehicle can take one or more actions based on the driving policies, waypoints, and/or controls. In systems, a result from the vehicle actions can be utilized to train one or more machine learning models described herein. For example, machine learning models can be updated based on one or more results for the vehicle action. In embodiments, the perception and/or prediction circuit can be updated (i.e. by imposing a penalty) when the system has made a mistake in predicting the intermediate representations at steps 406 and/or 454 (e.g. predicted 3D structure, depth, ego-motion, etc.). At step 408, the intermediate state of policies and/or controls trained using behavioral cloning can be regularized by the self-supervised learning of inductive biases as performed at step 406.

Method 450 can include step 402 for retrieving input data related to driving scenes. Method 450 can include step 454 for determining by self-supervised learning, intermediate representations of driving scenes. In other words, the intermediate representations can be generated in an un-supervised manner. The intermediate representations of driving scenes can include fixed and/or flexible structures.

Method 450 can include step 456 for determining based on expert demonstrations, vehicle controls and/or driving policies, while the intermediate representations imposed as constraints on the vehicle controls and/or driving policies. As such, at step 456, the intermediate state of policies and/or controls trained using behavioral cloning can be regularized by the self-supervised learning of inductive biases as performed at step 454.

As previously alluded to with reference to FIG. 2, the intermediate representations can have a fixed, semi-fixed, and/or flexible structure. The intermediate representations of driving scenes can correspond to one or more bounds or limits imposed on the waypoints, driving policy and/or controls. In embodiments, from the intermediate representations, one or more bounds and/or envelope constraints can be determined. These bounds and/or envelope constraints can be utilized together with expert demonstrations. As such, step 456 can assist in the method better learning driver.

The driving policies, waypoints, and/or controls (e.g. as determined by steps 408 and/or 456) can be utilized so that the vehicle can take one or more actions. Vehicle actions can include navigating towards a waypoint and/or navigating based on the determined policy. Vehicle actions can include diverting away from an obstacle, for example. In systems, a result from the vehicle actions can be utilized to train one or more machine learning models described herein. For example, machine learning models can be updated based on one or more results for the vehicle action. It should be appreciated that the above example vehicle response actions are merely illustrative and not exhaustive.

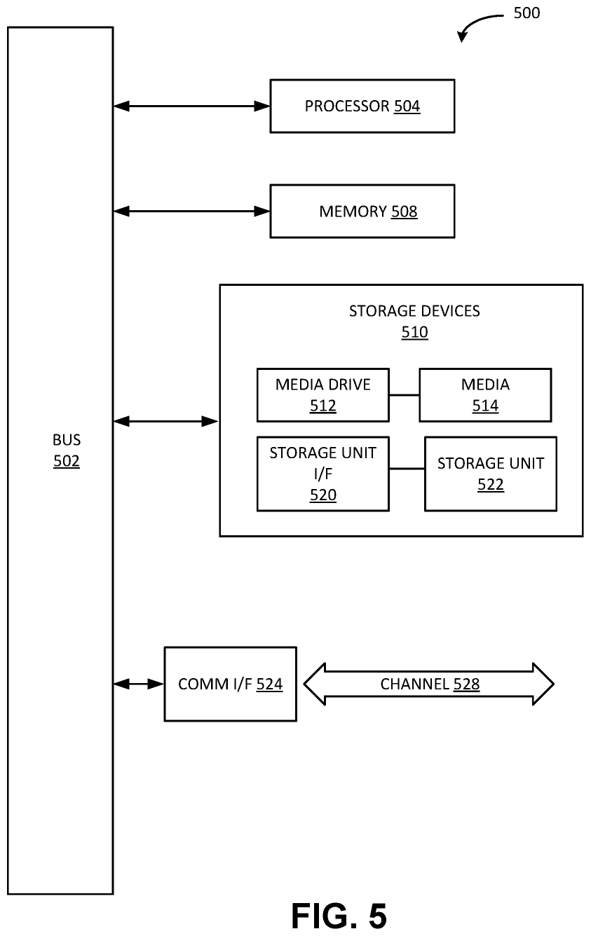

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor 506, the processor 306 (FIG. 3), or the like. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508, which may, in example embodiments, include the memory 308 (FIG. 3). For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
at least one memory storing machine-executable instructions; and
at least one processor configured to access the at least one memory and execute the machine-executable instructions to:
generate, by a self-supervised first machine learning model, an intermediate representation comprising inductive biases about the structure of driving scenes for a vehicle;
determine, by a second machine learning model trained by a set of expert demonstrations comprising labelled data, and based on the intermediate representation, a driving policy for the vehicle; and
generate a control signal for an actuator of the vehicle based on the determined driving policy.

2. The system of claim 1, wherein the intermediate representation comprises a component of a world model.

3. The system of claim 1, wherein the inductive biases comprise geometric scene decomposition.

4. The system of claim 3, wherein the geometric scene decomposition is inferred by self-supervised ego-motion and depth networks.

5. The system of claim 1, wherein the inductive biases comprise semantic inductive biases inferred from self-supervised scene flow.

6. The system of claim 1, wherein the inductive biases comprise temporal inductive biases.

7. The system of claim 1, wherein the inductive biases comprise freespace affordances generated by self-supervised depth analysis.

8. The system of claim 1, wherein the inductive biases comprise freespace affordances generated by self-supervised traversability analysis.

9. The system of claim 1, wherein the determined driving policy is determined by imposing the intermediate representations as constraints on unconstrained driving policies as determined based on the expert demonstrations.

10. The system of claim 1, where in the intermediate representations comprise fixed bounds within which the determined driving policy for the vehicle is determined.

11. A method, comprising:
generating, by a self-supervised first machine learning model, an intermediate representation comprising inductive biases about the structure of driving scenes for a vehicle;
determining, by a second machine learning model trained by a set of expert demonstrations comprising labelled data, and based on the intermediate representation, a driving policy for the vehicle; and
controlling an operation of the vehicle in response to a control signal generated based on the determined driving policy.

12. A method of claim 11, wherein the intermediate representation comprises a world model.

13. The method of claim 11, wherein the inductive biases comprise geometric scene decomposition.

14. The method of claim 13 wherein the geometric scene decomposition is inferred from a self-supervised ego-motion network.

15. The method of claim 13 wherein the geometric scene decomposition is inferred from self-supervised depth networks.

16. The method of claim 11, wherein the inductive biases comprise semantic inductive biases inferred from self-supervised scene flow.

17. The method of claim 11, wherein the inductive biases comprise temporal inductive biases.

18. The method of claim 11, wherein the inductive biases comprise freespace affordances generated by self-supervised depth and traversability analysis.

19. The method of claim 11, wherein the determined driving policy is determined by imposing the intermediate representations as constraints on unconstrained driving policies as determined based on the expert demonstrations.

20. The method of claim 11, where in the intermediate representations comprise fixed bounds within which the determined driving policy for the vehicle is determined.
